(19) United States
(12) Patent Application Publication
(10) Pub. No.: US 2004/0187418 A1
(43) Pub. Date: Sep. 30, 2004

(54) Decorative floating island

(76) Inventors: Luther B. Day, Raymond, MS (US); Chester F. Robards JR., Flora, MS (US)

Correspondence Address: John R. Hoffman, 13th Street, 616 W., P.O. Box 191, Jasper, IN, 47547, US

(21) Appl. No.: 10/346,329

(22) Filed: Jan. 17, 2003

(51) Int. Cl. A01G 9/02; B44F 9/00; B44F 7/00

(52) U.S. Cl. 52/315; 52/311.1; 52/309.1

(57) ABSTRACT

A decorative floating island is provided for a water garden, decorative pond or the like. The island includes a buoyant base for floating on a surface of a body of water. The base has a bottom side in floating engagement with the water and a top side exposed above the water. Landscaping structure covers substantially the entire top side of the buoyant base to substantially hide the base and give the appearance that the decorative floating island is a natural island.

### FIELD OF THE INVENTION

This invention relates to a decorative floating island for a water garden, decorative pond or the like.

### BACKGROUND OF THE INVENTION

The art of water gardening has become quite popular with gardening enthusiasts as well as professional landscapers. A water garden can range from a small installation which often is purchases as a kit by an individual to a large installation normally constructed by a professional landscape architect. Many water gardens also constitute fish ponds which increase the interest of property owners and visitors or guests alike.

A larger water garden obviously is more versatile for a gardening enthusiast. However, a problem with a larger water garden is the monotony of the large water surface area that it presents. This problem is just contrary to the aesthetic value of the garden in the first place. The landscaping engineer could install permanent islands to break the monotony of the water surface, but the construction, maintenance and regular servicing of such permanent islands is expensive and not time efficient. The present invention is directed to solving these problems by providing a decorative floating island which closely resembles a natural island and yet permits a variation in views as it moves or rotates.

Floating islands have been used in hydroponic agriculture for growing crops on the surface of a body of water to enhance seed germination and rapid growth of the particular crop. Unfortunately, floating islands for hydroponic agriculture are not aesthetically pleasing and certainly do not provide a decorative device designed to simulate a natural island. Typically, floating islands used in hydroponic agriculture have exposed framework or base structures which support the growing medium for the crop and in no way give the appearance of a natural island.

### SUMMARY OF THE INVENTION

An object, therefore, of the invention is to provide a decorative floating island for a water garden, decorative pond or the like, the island being easy to manufacture and of low maintenance.

In the exemplary embodiment of the invention, the decorative floating island includes buoyant base for floating on a surface of a body of water. The base has a bottom side in floating engagement with the water and a top side exposed above the water. Landscaping structure covers substantially the entire exposed top side of the buoyant base to substantially hide the base and give the appearance that the decorative floating island is a natural island.

According to one embodiment of the invention, the landscaping structure comprises natural stones on the top side of the base which may include a top surface and peripheral side surfaces. The natural stones may be adhered to both the top and side surfaces of the base. On the other hand, the natural stones may be disposed on the top surface, with the side surfaces including simulated natural landscaping features such as additional simulated stones.

According to another embodiment of the invention, the landscaping structure is formed integrally with the buoyant base. For instance, the buoyant base may be fabricated of molded foam material, with the landscaping structure being molded integrally with the top side of the base. The landscaping structure can comprise integrally molded, simulated stones. Still further, channels may be molded between the simulated stones and filled with such material as sand, with dams molded at selected positions in the channels to prevent the sand from migrating out of the channels into the water.

Other features of the invention include providing the landscaping structure with simulated plants. On the other hand, the top side of the buoyant base may be provided with at least one receptacle for receiving a natural plant. The receptacle may be formed to receive a potted plant with support means for supporting the potted plant at different elevations relative to the buoyant base.

Other objects, features and advantages of the invention will be apparent from the following detailed description taken in connection with the a accompanying drawings.

### BRIEF DESCRIPTION OF THE DRAWINGS

The features of this invention which are believed to be novel are set forth with particularity in the appended claims. The invention, together with its objects and the advantages thereof, may be best understood by reference to the following description taken in conjunction with the accompanying drawings, in which like reference numerals identify like elements in the figures and in which:

FIG. 1 is a perspective view of a decorative floating island according to one embodiment of the invention;

FIG. 2 is a view similar to that of FIG. 1, with a potted plant and a garden ornament added to the island;

FIG. 3 is a vertical section taken generally along line 3-3 of FIG. 2;

FIG. 4 is a view similar to that of FIG. 3, but with natural stones adhered to the edge of the base;

FIG. 5 is a perspective view of a decorative floating island according to a second embodiment of the invention;

FIG. 6 is a vertical section taken generally along line 6-6 of FIG. 5;

FIG. 7 is a view similar to that of FIG. 6, but with the base recessed at or below the water line;

FIG. 8 is a vertical section taken generally along irregular line 8-8 of FIG. 5;

FIG. 9 is an enlarged section through one of the plant pots, showing two different versions of the stackable spacer rings beneath the peripheral lip of the pot;

FIG. 10 is a view similar to that of FIGS. 3, 4, 6 and 7 but of a third embodiment of the invention; and

FIG. 11 is a view similar to that of FIG. 10 but of a fourth embodiment of the invention.

### DETAILED DESCRIPTION OF THE PREFERRED EMBODIMENTS

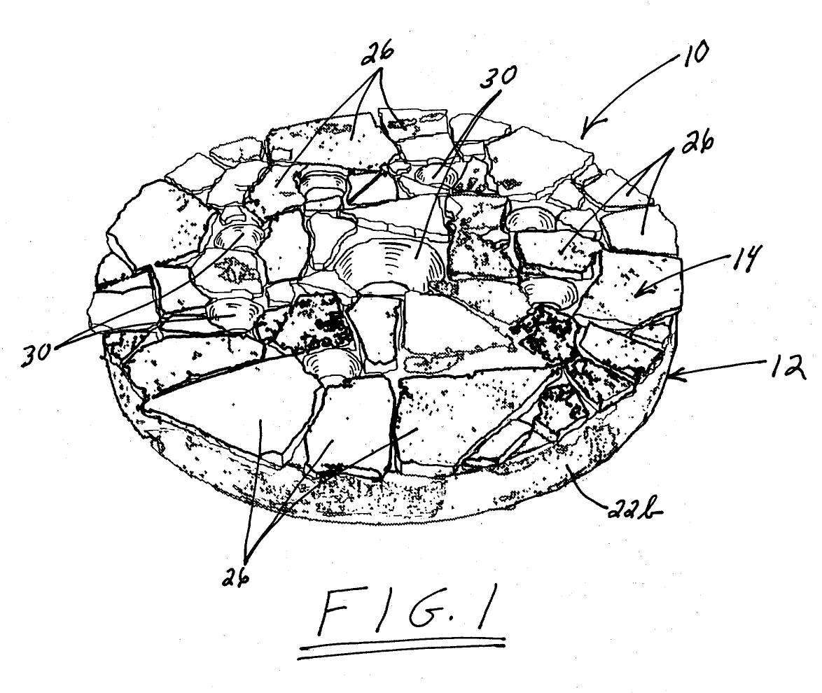

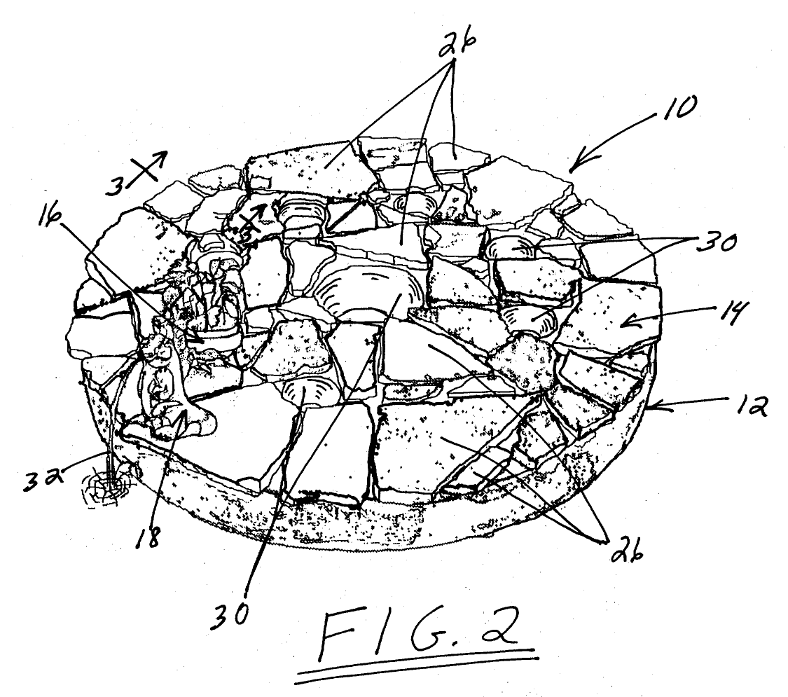

Referring to the drawings in greater detail, and first to FIG. 1, a first embodiment of a decorative floating island is shown and generally designated 10. The decorative floating island is provided for floating on the surface of water in a water garden, decorative pond or the like. The decorative floating island can also be used in natural or man-made lakes as well as naturally landscaped swimming pools. Generally, the island includes a buoyant base, generally designated 12, and a landscaping structure, generally designated 14, covering substantially the entire exposed surfaces of the base. FIG. 2 is a view similar to that of FIG. 1, but with a potted plant, generally designated 16, and a garden ornament, generally designated 18, added to the top of the island.

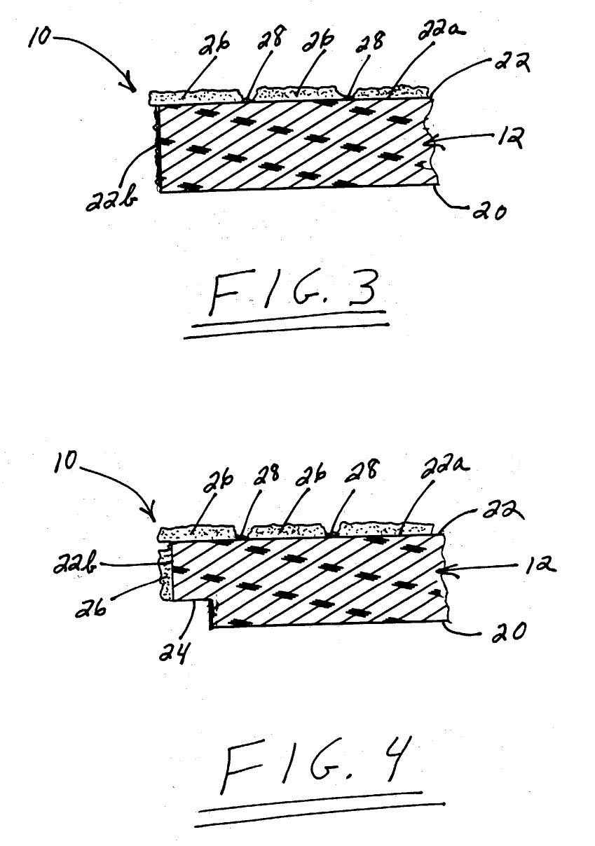

Referring to FIGS. 3 and 4 in conjunction with FIG. 1, buoyant base 12 of decorative island 10 is provided for floating the island on the surface of a body of water. The base is sufficiently buoyant to support whatever is placed on the top side thereof. The island can float freely around the surface of the body of water, or the island can be anchored or tethered to float in a limited space. In fact, the floating island can be held stationary to hide unsightly mechanisms at or near the surface of the water. The base has a bottom side 20 in floating engagement with the water and a top side 22 exposed above the water. Depending on the weight of the island, the water surface will be somewhere between bottom side 20 and top side 22. FIG. 4 shows the base recessed, as at 24, which corresponds generally to the surface of the water. Therefore, top side 22 includes a top surface 22a and side peripheral surfaces 22b. The entire base may be a one-piece structure of buoyant material, such as a structure fabricated of molded foam material. The base may have an infinite number of horizontal configurations, such as the round configuration shown in the drawings or a totally irregular configuration.

Generally, the invention contemplates that the top side 22 of base 12 which is exposed above the surface of the water to be covered substantially entirely with a landscaping structure or plants that gives the appearance that the decorative floating island is a natural island. In the first embodiment of FIGS. 1-4, landscaping structure 14 is provided by a plurality of natural stones 26 appropriately adhered to the exposed top side of the base. The cracks between the stones may be filled with a soil-simulated mortar 28 (FIGS. 3 and 4) or with sand, soil or a planting media. The natural stones are shown substantially flat in FIGS. 1-4, but the stones can be provided in any variety of three-dimensional configurations, to provide a natural look for the island.

FIGS. 1-4 show natural stones 26 covering substantially the entire top surface 22a of the exposed top side 22 of the base. FIGS. 1-3 show side surface 22b of the exposed top side of the base covered with a mortar-like substance which is textured to simulate stone, dirt or vegetation, again to give the appearance of a natural landscaping surface. FIG. 4 shows side surface 22b of the exposed top side 22 of the base covered with additional natural stones 26.

FIG. 1 shows that molded foam base 12 can be provided with one or a plurality of receptacles 30 for receiving simulated or actual plant or vegetation. The receptacles can be used, to position real or simulated plants (not shown). The receptacles can be directly filled with an appropriate potting medium for planting the vegetation directly into the receptacles. On the other hand, the receptacles can be used more conveniently for receiving a potted plant 16 as shown in FIG. 2. The receptacles allow the plants or vegetation to be readily changed, such as for changes in seasonal themes. Garden ornaments 18 (FIG. 2) also can be placed on top of decorative floating island 10. The garden ornament 18 shown in FIG. 2 is an animal that forms a water spout 32. A pump for the water spout can be embedded into the molded base and simply recycle water from the water garden or pond. The pump can be battery powered, or a solar panel (not shown) could be used to provide solar power to the pump and still allow the island to float freely around the body of water. If the island is anchored or tethered, an underwater electrical cord could lead to the pump.

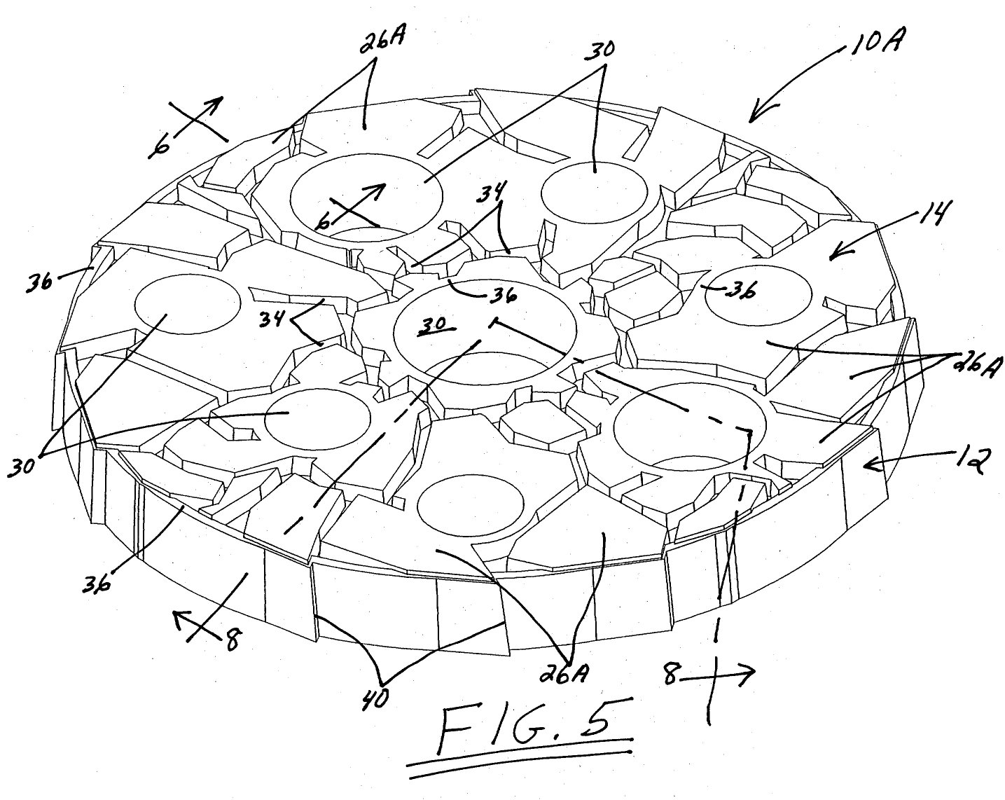

FIG. 5 shows a second embodiment of a decorative floating island, generally designated 10A, according to the invention and, again, includes a buoyant base, generally designated 12, for floating on the surface of a body of water, along with landscaping structure, generally designated 14, covering substantially the entire exposed top side of the buoyant base to substantially hide the base and give the appearance that the decorative floating island is a natural island. Again, island 10A has a plurality of receptacles 30 for receiving simulated or actual vegetation as well as potted plants 16 (FIG. 2). However, floating island 10A of FIG. 5 does not include actual or natural stones as with stones 26 on island 10 in FIG. 1. Island 10A is an entire one-piece molded structure including buoyant base 12 as well as landscaping structure 14.

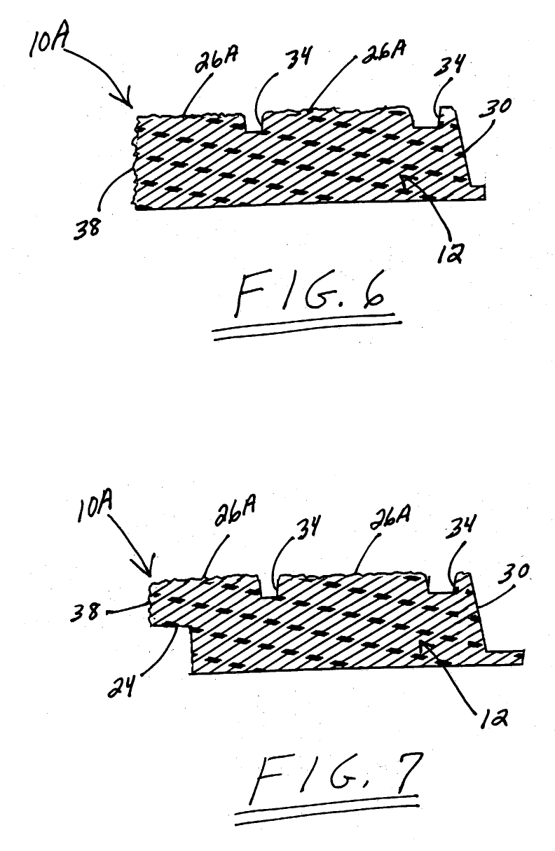

More particularly, referring to FIG. 6 in conjunction with FIG. 5, buoyant base 12 again can be molded of foam material, but the exposed surfaces of the base are integrally molded with simulated stones or stone profiles 26A to give the appearance of natural stones. The foam material can be molded with various textures and, in fact, varying colors can be added to further enhance the simulated natural appearance of the stone profiles. For instance, the foam material can be fabricated of polyurethane with a resin that can produce a natural stone appearance. A plurality of channels 34 are molded between simulated stones or stone profiles 26A whereby the channels can be filled with such material as sand, soil or a planting media to further enhance the natural appearance of the island. Dams 36 may be molded around the periphery of the island as well as around receptacles 30 to prevent the sand or soil from migrating out of channels 34 and into the water or into the receptacles.

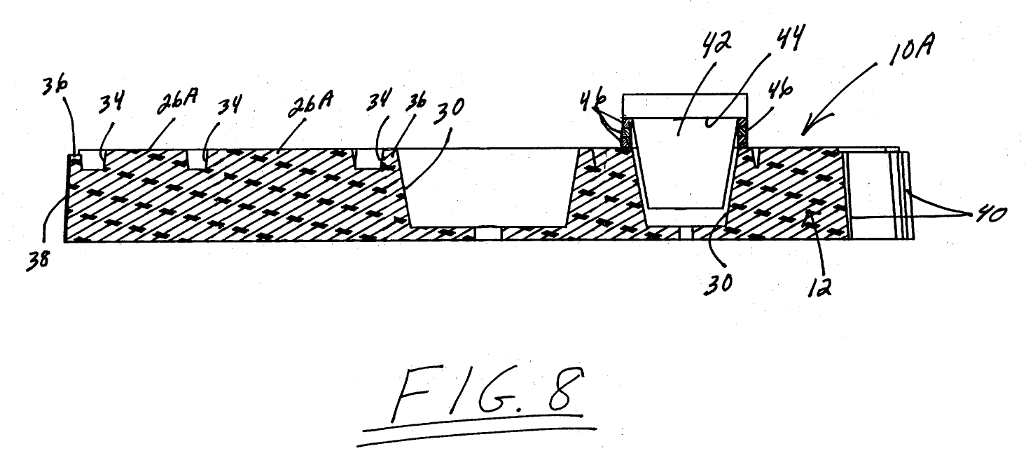

FIG. 5 shows that the peripheral side surfaces 38 of island 10A are molded with edge profiles 40 vertically aligned with the edges of the simulated stones or stone profiles 26A. FIG. 6 shows that peripheral side surfaces 38 may be molded with a stone or soil texture (similar to FIG. 3). FIG. 7 shows base 12 recessed at 24, generally at the water line, with peripheral side surfaces 38 again molded with a texture to simulate a natural substance. All of these side surface enhancements in FIGS. 5-7 are provided so that substantially the entire exposed top surface of the buoyant base gives the appearance that the decorative floating island is a natural island.

FIG. 8 shows a conventional plant pot 42 for receiving an artificial or natural plant and for positioning in one of the receptacles 30 in the second embodiment 10A of the decorative floating island of the invention. Of course, the following description is equally applicable for the first Embodiment 10 of the decorative floating island. As is known, the conventional pot 32 includes a peripheral, downwardly facing ring or lip 44. It is contemplated that the pot can be supported in receptacle 30 at different elevations relative to buoyant base 12 in order to position the pot at a desired elevation relative to the water level in the garden or pond. A wick (not shown) can extend downwardly from the pot into the body of water to allow for controlled watering of the plant in the pot.

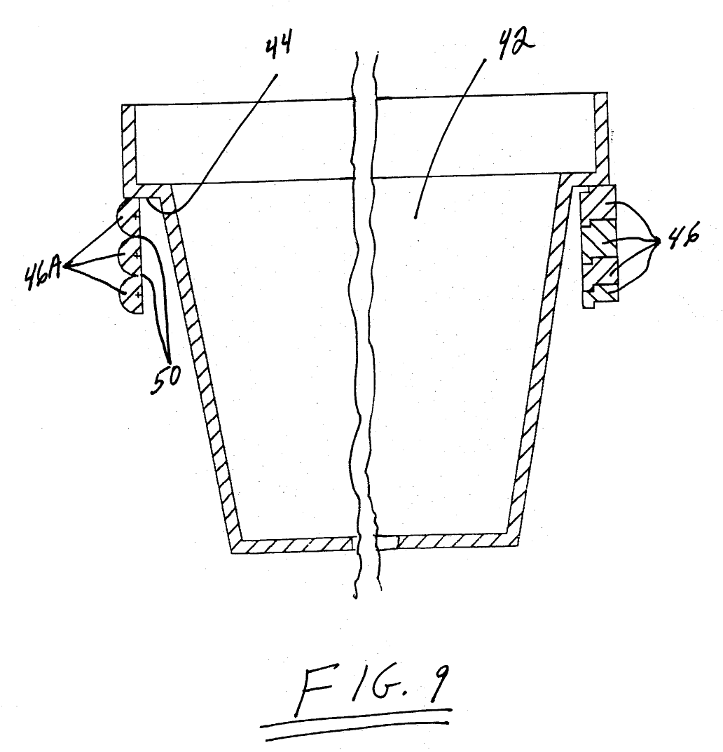

Specifically, referring to the right-hand side of FIG. 9 in conjunction with FIG. 8, a plurality of stackable rings 46 are positioned on top of each other and are sandwiched between lip 44 of pot 42 and the top of the floating island, such as on the top of stone profiles 26A. The numbers of rings and the sizes of the rings can be varied to vary the elevation of pot 42 relative to buoyant base 12 of the floating island. This, in turn, is effective to vary the elevation of the pot relative to the surface of the body of water on which the floating island floats. The left-hand side of FIG. 9 shows a plurality of stacked rings 46A which are joined by frangible webs 50. Therefore, rings 46A can be broken away from each other to vary the effective stacking height thereof and, thereby, vary the height of the pot.

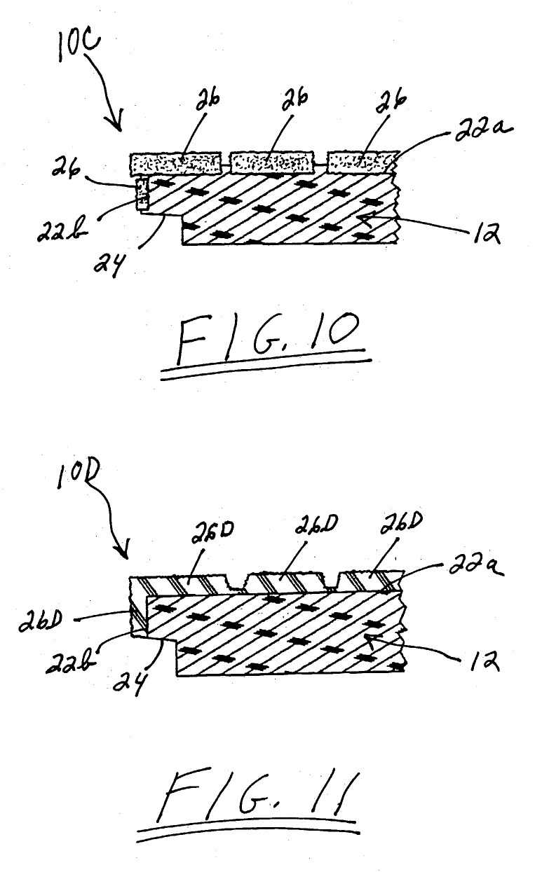

FIG. 10 shows a third embodiment of the invention which is a hybrid of the first and second embodiments. Specifically, a plurality of natural stones 26 are insert molded in a molded foam base 12 to form a floating island 10C. This is easily fabricated by placing the stones in a mold and pouring a liquid foam material into the mold on top of or over the stone . Upon curing, the foam material unifies the stones integral with the base. The stones are shown in FIG. 10 on both the top surface 22a and side peripheral surfaces 22b of the base.

FIG. 11 shows a fourth embodiment of a decorative floating island 100 which is a variation of the second embodiment 10B which is integrally or unitarily molded. Specifically, floating island 10D includes a foam base 12 to which a molded landscaping structure in the form of simulated stones 26D are adhered. Base 12 can be molded of a plastic buoyant material of one density, and landscaping structure 260 can be molded of a material which is more dense and which can better simulate natural stones. This is easily fabricated by molding landscaping structure 26D in a molding die and then molding base 12 thereover. The landscaping structure could be molded of a fiberglass material or the like. The landscaping structure also can be cast of concrete to simulate natural stones, and base 12 is molded over the cast concrete.

It will be understood that the invention may be embodied in other specific forms without departing from the spirit or central characteristics thereof. The present examples and embodiments, therefore, are to be considered in all respects as illustrative and not restrictive, and the invention is not to be limited to the details given herein.

1. A decorative floating island for a water garden, decorative pond and the like, comprising:
a buoyant base for floating on a surface of a body of water, the base having a bottom side in floating engagement with the water and a top side exposed above the water; and
landscaping structure covering substantially the entire top side of said buoyant base to substantially hide the base and give the appearance that the decorative floating island is a natural island.

2. The decorative floating island of claim 1 wherein said landscaping structure includes natural stones on the top side of the base.

3. The decorative floating island of claim 2 wherein the top side of said buoyant base includes a top surface and peripheral side surfaces, and said natural stones are adhered to both the top and side surfaces of the base.

4. The decorative floating island of claim 2 wherein the top side of said buoyant base includes a top surface and peripheral side surfaces, said natural stones being disposed on the top surface, and the side surfaces including simulated natural landscaping features.

5. The decorative floating island of claim 1 wherein said landscaping structure is formed integrally with the buoyant base.

6. The decorative floating island of claim 5 wherein said buoyant base is fabricated of molded foam material, with the landscaping structure being molded integrally with the top side of the base.

7. The decorative floating island of claim 6 wherein said landscaping structure comprises integrally molded, simulated stones.

8. The decorative floating island of claim 7 wherein said landscaping structure has channels molded between the simulated stones whereby the channels can be filled with such material as sand, soil, a planting media and similar substances.

9. The decorative floating island of claim 8 wherein said landscaping structure has dams at selected positions in the channels to prevent the sand from migrating out of the channels into the water.

10. The decorative floating island of claim 1 wherein said landscaping structure includes natural or simulated plants.

11. The decorative floating island of claim 1 wherein the top side of said buoyant base includes at least one receptacle for receiving a natural or artificial plant.

12. The decorative floating island of claim 11 wherein said receptacle is formed to receive a plant pot.

13. The decorative floating island of claim 12, including support means for supporting the plant pot at different elevations relative to the buoyant base.

14. The decorative floating island of claim 13 wherein said support means include a plurality of stackable spacer rings positionable in selected numbers between the plant pot and the buoyant base.

15. A decorative floating island for a water garden, decorative pond and the like, comprising:
a buoyant base for floating on a surface of a body of water, the base having a bottom side in floating engagement with the water and a top side exposed above the water;
landscaping structure covering the top side of said buoyant base to give the appearance that the decorative floating island is a natural island, said landscaping structure including natural stones on the top side of the base; and
at least one receptacle in the top side of the buoyant base amidst the natural stones for receiving an artificial or natural plant.

16. The decorative floating island of claim 15 wherein the top side of said buoyant base includes a top surface and peripheral side surfaces, and said natural stones are adhered to both the top and side surfaces of the base.

17. The decorative floating island of claim 15 wherein the top side of said buoyant base includes a top surface and peripheral side surface said natural stones being disposed on the top surface, and the side surfaces including simulated natural landscaping features.

18. The decorative floating island of claim 15 wherein said receptacle is formed to receive a plant pot.

19. The decorative floating island of claim 18, including support means for supporting the plant pot at different elevations relative to the buoyant base.

20. The decorative floating island of claim 19 wherein said support means include a plurality of stackable spacer rings positionable in selected numbers between the plant pot and the buoyant base.

21. A decorative floating island for a water garden, decorative pond and the like, comprising:
a buoyant base for floating on a surface of a body of water, the base having a bottom side in floating engagement with the water and a top side exposed above the water;
landscaping structure formed integrally with the buoyant base and covering the top side of said buoyant base to give the appearance that the decorative floating island is a natural island; and
at least one receptacle formed integrally with the buoyant base amidst the landscaping structure for receiving an artificial or natural plant.

22. The decorative floating island of claim 21 wherein said buoyant base is fabricated of molded foam material, with the landscaping structure being molded integrally with the top side of the base.

23. The decorative floating island of claim 22 wherein said landscaping structure comprises integrally molded, simulated stones.

24. The decorative floating island of claim 23 wherein said landscaping structure has channels molded between the simulated stones whereby the channels can be filled with such material as sand, soil, a planting media and similar substances.

25. The decorative floating island of claim 24 wherein said landscaping structure has dams at selected positions in the channels to prevent the sand from migrating out of the channels into the water.

26. The decorative floating island of claim 21 wherein said receptacle is formed to receive a plant pot.

27. The decorative floating island of claim 26, including support means for supporting the plant pot at different elevations relative to the buoyant base.

28. The decorative floating island of claim 27 wherein said support means include a plurality of stackable spacer rings positionable in selected numbers between the plant pot and the buoyant base.

29. A decorative floating island for a water garden, decorative pond and the like, comprising:
a buoyant base for floating on a surface of a body of water, the base having a bottom side in floating engagement with the water and a top side exposed above the water;
landscaping structure formed integrally with the buoyant base and covering the top side of said buoyant base to give the appearance that the decorative floating island is a natural island; and
said buoyant base being of a buoyant material different from the material of the landscaping structure.

30. The decorative floating island of claim 29 wherein said landscaping structure comprise a plurality of stones insert molded in the buoyant base.

31. The decorative floating island of claim 30 wherein said buoyant base is fabricated of molded foam material.

32. The decorative floating island of claim 29 wherein said landscaping structure is fabricated of a molded material which has a greater density than the buoyant base which is fabricated of a molded material.

33. The decorative floating island of claim 32 wherein said base is molded of a foam material and said landscaping structure is molded of fiberglass.

34. The decorative floating island of claim 32 wherein said base is molded of a foam material and said landscaping structure is molded of a more dense plastic material.

35. The decorative floating island of claim 29 wherein said base is molded of a foam material and said landscaping structure is cast of concrete material.
